(19) United States
(12) Patent Application Publication
(10) Pub. No.: US 2010/0229139 A1
(43) Pub. Date: Sep. 9, 2010

(54) SYSTEM AND METHOD FOR DESIGNING SEMICONDUCTOR INTEGRATED CIRCUIT

(75) Inventors: Miyako KITAOKA, Tokyo (JP); Kazunari KIMURA, Kanagawa-ken (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/702,129

(22) Filed: Feb. 8, 2010

(30) Foreign Application Priority Data
Mar. 9, 2009 (JP) 2009-055539

(51) Int. Cl. G06F 17/50

(52) U.S. Cl. 716/6; 716/5; 716/12

(57) ABSTRACT

An extraction unit extracts a metal pattern constituting a semiconductor integrated circuit from layout data. A setting unit sets up a region including the metal pattern extracted by the extraction unit. An evaluation unit calculates the metal coverage rate of the region and to evaluate whether the metal coverage rate is equal to or more than a predetermined value. An insertion unit inserts a dummy metal pattern into the region when the metal coverage rate is evaluated as a value smaller than the predetermined value by the evaluation unit.

### CROSS REFERENCE TO RELATED APPLICATION

This application is based upon and claims the benefit of priority from the prior Japanese Patent Application No. 2009-55539, filed on Mar. 9, 2009, the entire contents of which are incorporated herein by reference.

### FIELD OF THE INVENTION

This invention relates to a system for designing a semiconductor integrated circuit and to a method for designing a semiconductor integrated circuit.

### DESCRIPTION OF THE BACKGROUND

In a semiconductor integrated circuit, the density of metal wirings is different depending on position on a substrate, in many cases. When the density of metal wirings is much different depending on position on a substrate, the etching speed of the metal wirings varies from position to position on the substrate in an etching step arranged in manufacturing a semiconductor integrated circuit. As a result, width variation of metal wirings arises depending on position on a substrate.

Japanese Patent Application Publication No. 2002-50626 (Page 5, FIG. 1) shows an improvement for the above problem. According to the improvement, the density of wiring patterns is controlled to within 25% to 85%.

Further, in recent years, variation in film thickness of metal wirings has become more remarkable with progress of miniaturization of a semiconductor integrated circuit, in addition to the problem of variation in width of metal wirings as described above. The variation in film thickness is caused by variation in metal coverage rate of a metal wiring layer, which depends on position on a substrate. The metal coverage rate is an area ratio of a metal covered portion to a unit region of a substrate.

With decrease of the film thickness of metal wirings of a path, whose signal timing is critical, the resistance of the metal wirings increases so that the signal delay of the metal wirings increases. The increase of the signal delay may influence the timing margin of operation of a semiconductor integrated circuit.

Variation of film thickness of the metal wirings becomes larger on the substrate as the metal coverage rate of the metal wiring layer is lower. An improvement is known for prevent variation of film thickness. The improvement is that the variation of film thickness of metal wirings can be reduced by forming a dummy metal pattern layer on the substrate additionally so as to increase the metal coverage rate up to 50% or more, for example. In this case, in order to avoid influence of the variation in film thickness of the metal wirings on timing margin, it is desirable that the metal coverage rate of the metal wiring layer, which includes the metal wirings, is set equal to or more than 50% all over the substrate.

However, when the improvement is applied to multi-layer wirings, a dummy metal pattern layer, which is added to metal wirings formed in a lower layer, may change the distance from a substrate to a metal wiring formed in an upper layer and stacked above the dummy metal pattern layer.

The capacitance of the metal wiring of the upper layer changes with respect to the substrate, as the distance between the substrate and the metal wiring of the upper layer changes. Accordingly, the positional relationship between the wirings formed in the upper and the lower layers needs to be considered when a dummy metal pattern layer is added. Thus, a problem arises that a large amount of designing time is required when a dummy metal pattern layer is added to making the metal coverage rate high all over the substrate.

### SUMMARY OF THE INVENTION

An aspect of the present invention provides a system for designing a semiconductor integrated circuit, including a first extraction unit to extract a first metal pattern constituting a semiconductor integrated circuit from layout data, a first setting unit to set up a first region including the first metal pattern extracted by the extraction unit, an evaluation unit to calculate the metal coverage rate of the first region and to evaluate whether the metal coverage rate is equal to or more than a predetermined value, and an insertion unit to insert a dummy metal pattern into the first region when the metal coverage rate is evaluated as a value smaller than the predetermined value by the evaluation unit.

An aspect of the present invention provides a method for designing a semiconductor integrated circuit, including extracting a first metal pattern constituting a semiconductor integrated circuit from layout data, setting up a first region including the first metal pattern, calculating the metal coverage rate of the first region and evaluating whether the metal coverage rate is equal to or more than a predetermined value, and inserting a dummy metal pattern into the first region when the metal coverage rate is evaluated as a value smaller than the predetermined value.

### BRIEF DESCRIPTION OF THE DRAWINGS

FIG. 1 is a block diagram showing a configuration of a system for designing a semiconductor integrated circuit according to a first embodiment of the invention.

FIG. 2 is a table showing a relationship between the metal coverage rate of a metal wiring layer and the rate of variation of metal film thickness.

FIG. 3 is a flowchart showing a method of reducing variation in film thickness of metal wirings.

FIGS. 4A to 4C are pattern layout views schematically showing an execution example of the flow of FIG. 3.

FIGS. 5A and 5B are flowcharts showing another method of reducing the variation in film thickness of metal wirings.

FIGS. 6A to 6C are pattern layout views schematically showing an execution example of the flow of FIG. 5.

FIG. 7 is a flowchart showing a method of preventing a clock skew of a clock signal.

FIG. 8A is a circuit diagram showing an example of a clock tree to which the flow of FIG. 7 is applied.

FIGS. 8B and 8C are pattern layout views schematically showing an execution example obtained by applying the flow of FIG. 7 to the circuit of FIG. 8A.

FIG. 9 is a circuit diagram showing an example of the clock tree.

FIGS. 10A and 10B are schematic cross-sectional views showing a multi-layer wired semiconductor integrated circuit.

FIG. 11 is a block diagram showing a configuration of a system for designing a semiconductor integrated circuit according to a second embodiment of the invention.

FIG. 12 is a flowchart showing a method of reducing the variation in film thickness of a metal wiring for a path whose signal timing is critical, in the case of a multi-layer wired semiconductor integrated circuit.

FIG. 13 is a pattern layout view schematically showing an execution example of the flow of FIG. 12.

### DETAILED DESCRIPTION OF THE INVENTION

Embodiments of the invention will be described with reference to the drawings. In the drawings, same reference numerals indicate same or similar portions respectively.

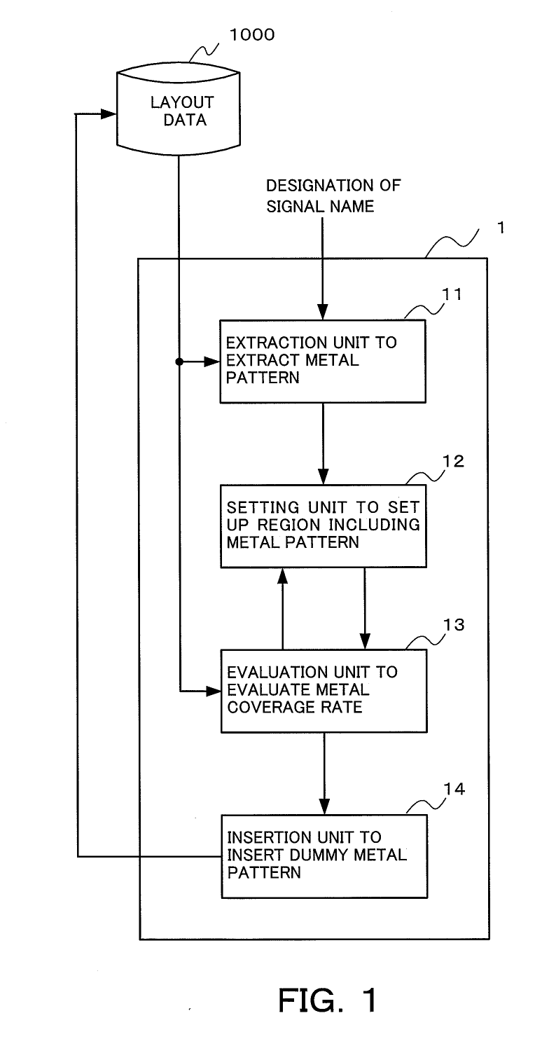

A system and a method for designing a semiconductor integrated circuit according to a first embodiment will be described. FIG. 1 is a block diagram showing a configuration of the system according to the first embodiment.

As shown in FIG. 1, a system 1 for designing a semiconductor integrated circuit of the embodiment is provided with a memory device 1000, an extraction unit 11 to extract a metal pattern, a setting unit 12 to set up a region having a predetermined area and including the metal pattern, an evaluation unit 13 to evaluate the metal coverage rate, and an insertion unit 14 to insert a dummy metal pattern.

The memory device 1000 stores layout data of metal patterns. The extraction unit 11 extracts a metal pattern corresponding to a designated signal name from the layout data stored in the memory device 1000.

The setting unit 12 sets up a region which has a predetermined area and which includes the metal pattern extracted by the extraction unit 11.

The evaluation unit 13 calculates the metal coverage rate of the region set up by the setting unit 12. The evaluation unit 13 evaluates whether the calculated metal coverage rate is equal to or more than a predetermined value.

When the evaluation unit 13 evaluates the calculated metal coverage rate as less than the predetermined value, the insertion unit 14 inserts a dummy metal pattern into the region.

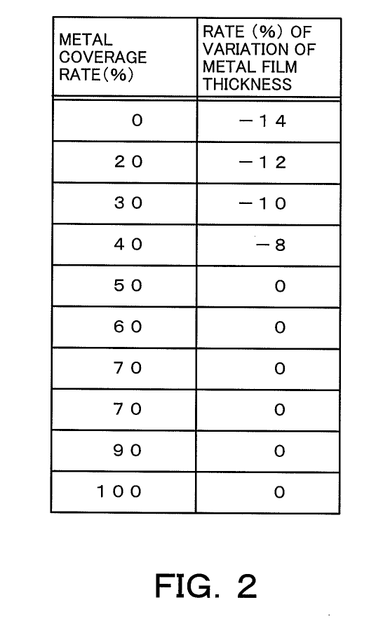

FIG. 2 is a table showing a relation between the metal coverage rate and the rate of variation of metal film thickness in a semiconductor integrated circuit which is to be designed by the system 1.

As shown in FIG. 2, in the semiconductor integrated circuit to be designed, the metal film thickness does not vary when the metal coverage rate is not less than 50%.

When the metal coverage rate is less than 50%, the variation of the metal film thickness occurs. The lower the metal coverage rate, the more the metal film thickness decreases.

If decrease of film thickness occurs in a metal wiring for a signal with a very small timing margin, a timing error is more likely to occur.

In the system 1, when a signal with a small timing margin is designated and a name of the signal is inputted, the metal pattern corresponding to the signal name is extracted from the layout data stored in the memory device 1000. The system 1 inserts a dummy metal pattern, as described in detail below, so that the metal coverage rate of a region including the extracted metal pattern is equal to or more than 50%.

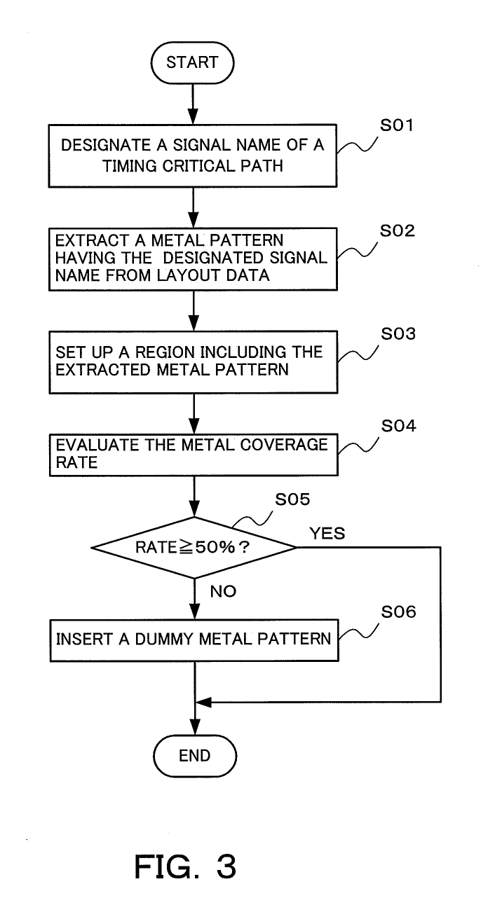

FIG. 3 shows a processing flow of the system 1 when a signal of a timing critical path is designated as a signal with a small timing margin.

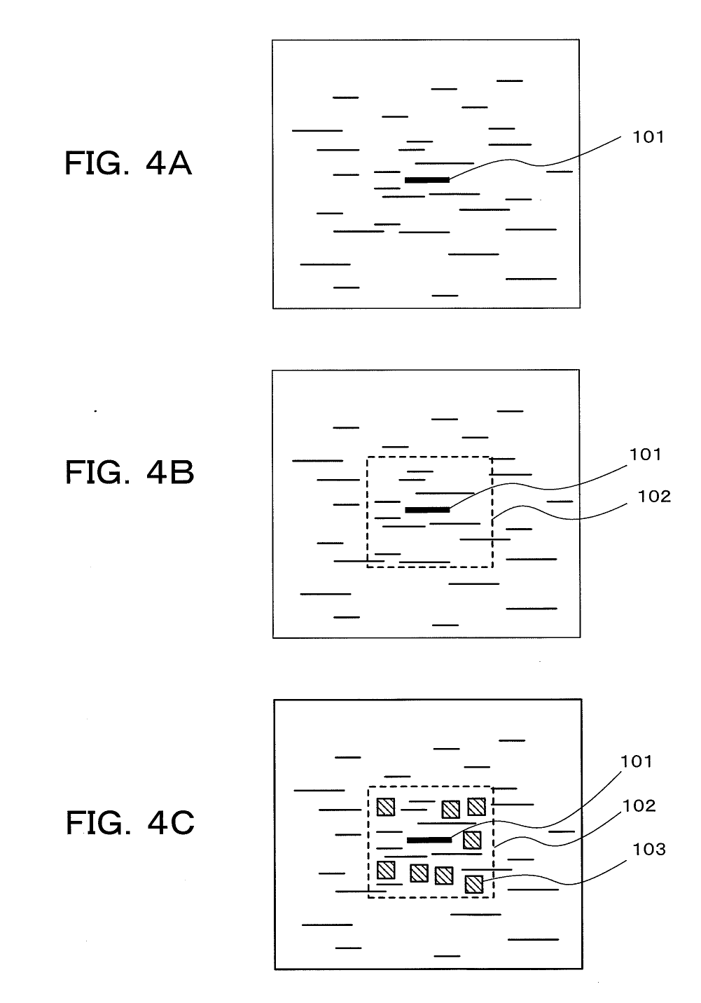

The processing flow of the system 1 will be described using the flowchart of FIG. 3 and pattern layout views schematically shown in FIGS. 4A to 4C.

A signal name of a timing critical path is inputted to the system 1 to be designated, at the start of the processing flow of FIG. 3 (step S01).

Upon the designation of the signal name of the timing critical path, as shown in FIG. 4A, the extraction unit 11 extracts a metal pattern 101 corresponding to the designated signal name from the layout data stored in the memory device 1000 (step S02).

Subsequently, the setting unit 12 sets up a region 102 having a predetermined area and including the extracted metal pattern 101 as shown in FIG. 4B (step S03).

After the step S03, the evaluation unit 13 calculates the metal coverage rate of the region 102 (step S04). The evaluation unit 13 then evaluates whether the calculated metal coverage rate is equal to or more than 50% (step S05).

As a result of the evaluation, if the metal coverage rate is equal to or more than 50%, the processing flow is directly terminated. If the metal coverage rate is less than 50%, the insertion unit 14 inserts a dummy metal pattern 103 into the region 102 as shown FIG. 4C.

The metal coverage rate of the region 102, which includes the metal pattern of the critical path with a small timing margin, can be increased by inserting the dummy metal pattern, though the metal coverage rate of the entire chip cannot be increased. It is therefore possible to reduce the variation of film thickness of the metal wiring of the timing critical path, and thus to reduce the variation of the timing margin of the timing critical path.

The larger the metal coverage rate of the region for metal wiring becomes by narrowing the area of the region for metal wiring, the more the effect of reducing the variation of film thickness of the metal wiring of the timing critical path increases. However, when the region is narrow and the wiring density is high to some extent, a sufficient space may not be ensured for inserting the dummy metal pattern in some cases even when the metal coverage rate is less than 50%.

A method of disposing the dummy metal pattern will be described. By the method, a dummy metal pattern can be formed as closely to a metal wiring of a timing critical path as possible, even when a sufficient space is not ensured for inserting the dummy metal pattern so that the dummy metal pattern cannot be disposed extremely close to the metal wiring. According to this method, a region to be calculated is enlarged in a step-by-step manner to obtain a metal coverage rate so that space for the dummy metal pattern may be ensured.

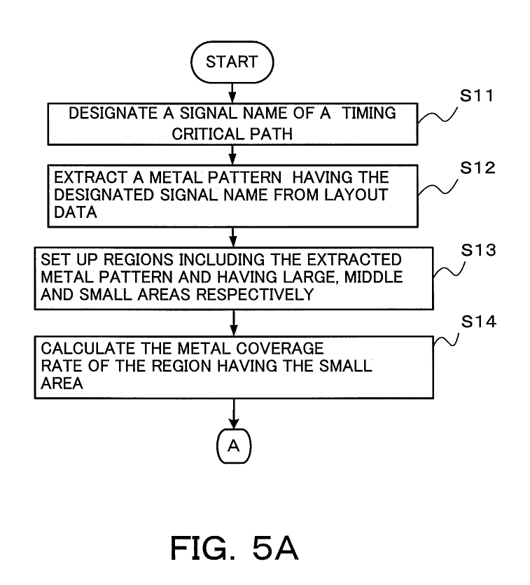

FIGS. 5A and 5B show flowcharts of the method. The method carries out inserting a dummy metal pattern into a region for a metal wiring while increasing the size of the region to calculate the metal coverage rate of the region.

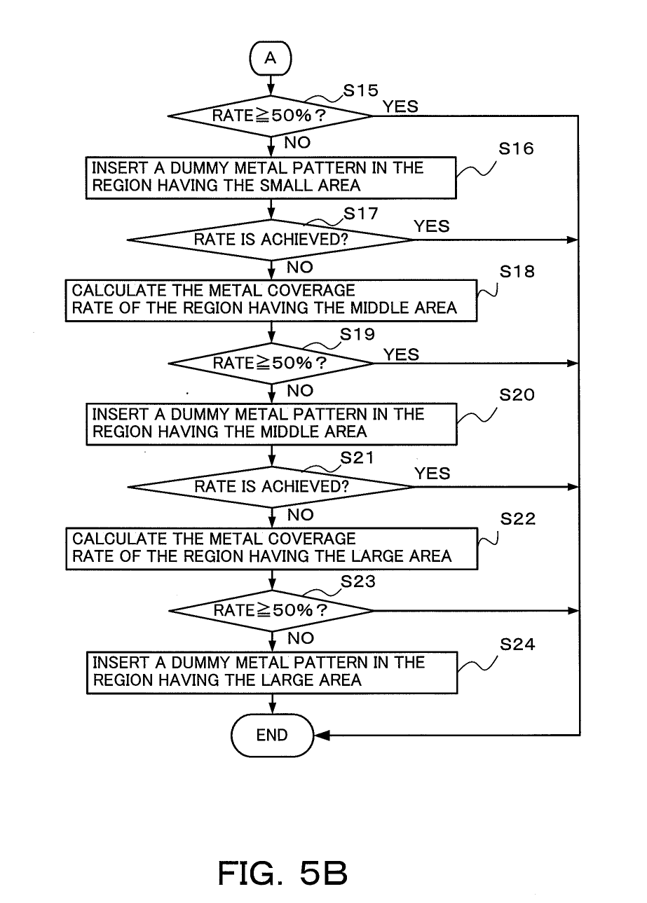

FIGS. 6A and 6B are a pattern layout view schematically showing an execution example of the flow of FIGS. 5 A and 5B.

A signal name of a timing critical path is inputted to the system 1 to designate the signal name, in order to start the processing of the flow of FIG. 5 (step S11).

Upon the designation of the signal name, as shown in FIG. 6A, the extraction unit 11 extracts a metal pattern 201 of a timing critical path from the layout data stored in the memory device 1000 (step S12).

Subsequently, the setting unit 12 sets up three regions which include the extracted metal pattern 201 respectively and which have different areas, that is, a small-area region 202, a middle-area region 203, and a large-area region 204 respectively (step S13). The number of the regions including the metal pattern 201 and having different areas is not limited to three and may be more than one.

After the step S13, the evaluation unit 13 calculates the metal coverage rate of the small-area region 202 (step S14). As shown in FIG. 5B, the evaluation unit 13 evaluates whether the calculated metal coverage rate is equal to or more than 50% (step S15).

As a result of the evaluation at step S15, if the metal coverage rate is equal to or more than 50%, the processing of the flow is directly terminated. If the metal coverage rate is less than 50%, the insertion unit 14 inserts a dummy metal pattern to the small-area region 202 when there is an enough space to insert the dummy metal pattern (step S16).

In the example shown in FIG. 6A, the small-area region 202 does not have sufficient space. The dummy metal patterns cannot be inserted into the small-area region 202.

Subsequently, in order to examine the effect of inserting the dummy metal pattern, the evaluation unit 13 again calculates the metal coverage rate of the small-area region 202. Moreover, the evaluation unit 13 evaluates whether the metal coverage rate achieves 50% or more (step S17).

As a result of the evaluation, if the metal coverage rate is 50% or more, the processing of the flow is terminated. If the metal coverage rate is less than 50%, the evaluation unit 13 calculates the metal coverage rate of the middle-area region 203 (step S18). The evaluation unit 13 evaluates whether the calculated metal coverage rate is equal to or more than 50% (step S19).

As a result of the evaluation at step S19, if the metal coverage rate is 50% or more, the processing of the flow is terminated. If the metal coverage rate is less than 50%, the insertion unit 14 inserts a dummy metal pattern 205 into the middle-area region 203 as shown in FIG. 6B (step S20).

In order to examine the effect of inserting the dummy metal pattern, the evaluation unit 13 again calculates the metal coverage rate of the middle-area region 203 and evaluates whether the metal coverage rate achieves 50% or more (step S21).

As a result of the evaluation at step S21, if the metal coverage rate is 50% or more, the processing of the flow is terminated. If the metal coverage rate is less than 50%, the evaluation unit 13 calculates the metal coverage rate of the large-area region 204 (step S22). The evaluation unit 13 evaluates whether the calculated metal coverage rate is equal to or more than 50% (step S23).

As a result of the evaluation at step S23, if the metal coverage rate is 50% or more, the processing of the flow is terminated. If the metal coverage rate is less than 50%, the insertion unit 14 inserts a dummy metal pattern 205 into the large-area region 204 as shown in FIG. 6C (step S24) so that the processing of the flow is terminated.

By the method, even though a sufficient space can not be available to insert the dummy metal pattern in the small-area containing the metal wiring and the dummy metal patterns can not be disposed extremely close to the metal wiring of the timing critical path, the metal coverage rates of the middle-area or the large-area regions containing the metal wiring can be increased. Such a method may minimize variation in film thickness of the metal wiring of the timing critical path.

A problem of variations in arrival time of a clock signal, which arise at end terminals of a clock wiring when the clock signal has a very small timing margin, will be described. Prevention of such variations, which is attained by inserting a dummy metal pattern in the case, will be also described.

In a semiconductor integrated circuit, arrival times, at which a clock signal reaches end terminals of a clock wiring, vary. Such variations of the arrival times of the clock signal are called as “clock skew”. Generally, a synchronously designed semiconductor integrated circuit includes a clock tree structure for the purpose of reducing the clock skew at end terminals of a clock wiring. In the clock tree structure, clock buffers are disposed in a tree fashion for distribution of the clock wiring. In such a clock tree structure, delay times, which are caused through clock wirings branched at branch points, remain balanced as originally designed so that the clock skew can be prevented.

However, when differences exist in metal coverage rate among regions including branched clock wirings respectively, the delay times through the branched clock wirings are unbalanced so that clock skew is caused at end terminals of the branched clock wirings.

A method of preventing the clock skew will be described. The method allows regions including branched clock wirings to have the same metal coverage rate using the system of the first embodiment.

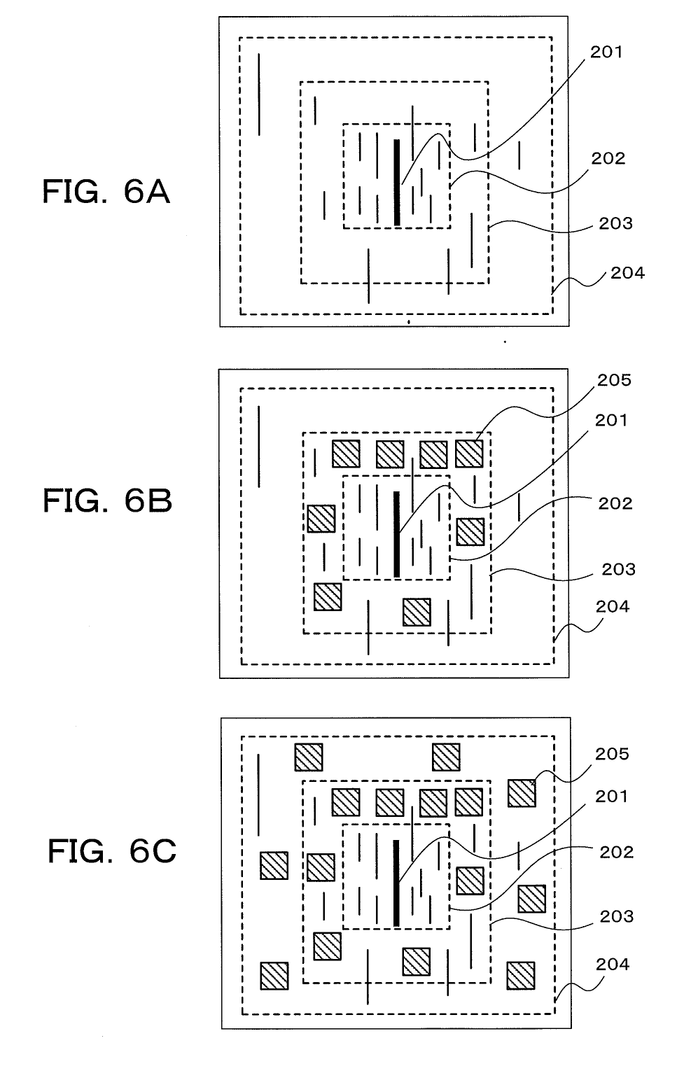

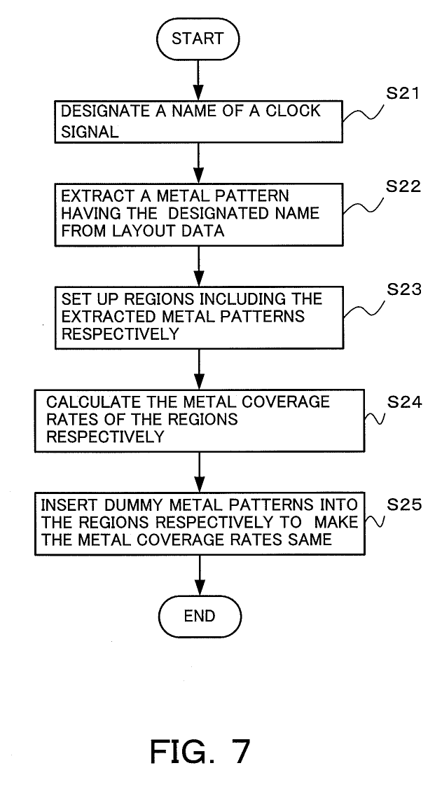

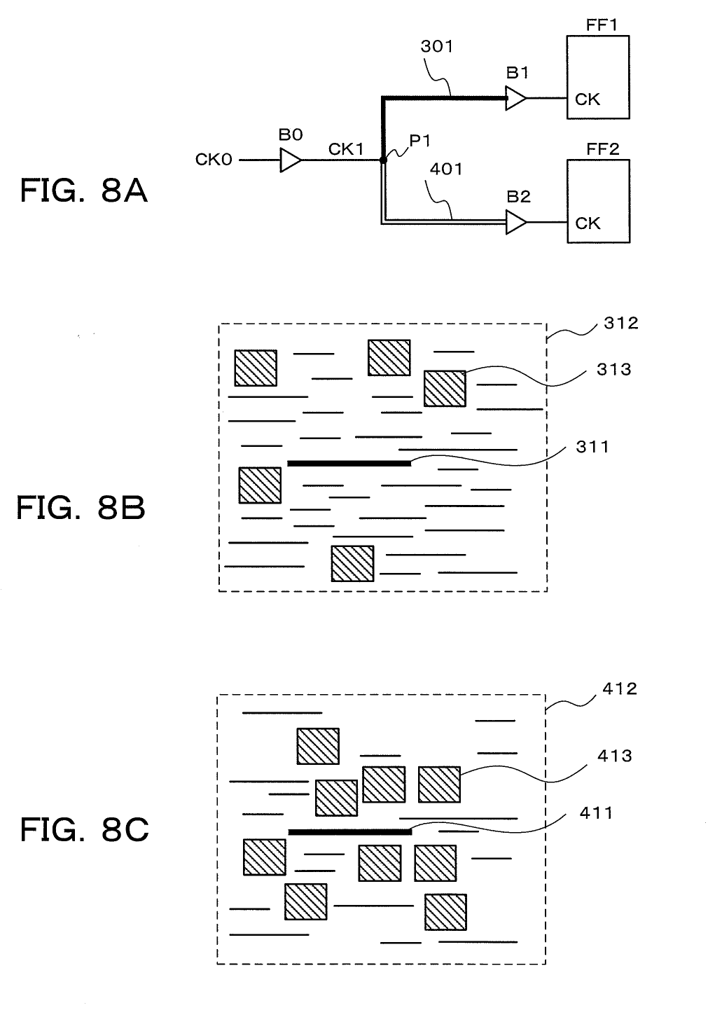

FIG. 7 is a flowchart of the method of preventing clock skew. FIG. 8A is a circuit diagram showing an example of the clock tree to which the flow of FIG. 7 is applied. FIGS. 8B, 8C are pattern layout views schematically showing an execution example obtained by applying the flow of FIG. 7 to the circuit of FIG. 8A.

As shown in FIG. 7, a name of a clock signal is inputted to the system 1 to be designated, at the start of the flow of FIG. 7 (step S21).

A signal name CK1 of output of a clock buffer B0 of the circuit, which is shown in FIG. 8A, is designated, for example. The clock signal CK1 is transmitted through clock wirings 301 and 401, which branch at a branch point P1 and which are connected to clock buffers B1, B2, respectively. The outputs from the clock buffers B1, B2 are inputted to clock signal input terminals CK of flip-flop circuits FF1, FF2 respectively.

Upon the designation of the signal name CK1 of the clock signal, the extraction unit 11 extracts metal patterns, through which the clock signal is transmitted, from layout data stored in a memory device 1000 (step S22).

In more detail, the extraction unit 11 extracts a metal pattern 311 shown in FIG. 8B, which corresponds to the clock wiring 301 of FIG. 8A. The extraction unit 11 also extracts a metal pattern 411 shown in FIG. 8C, which corresponds to the clock wiring 401 of FIG. 8A.

Subsequently, the setting unit 12 sets up regions which have a predetermined area and which include the extracted metal patterns respectively (step S23).

In more detail, the setting unit 12 sets up a region 312 for the metal pattern 311 of FIG. 8B, and sets up a region 412 for the metal pattern 411 of FIG. 8C.

After the setting-up, the evaluation unit 13 calculates the metal coverage rates for the region 312 shown in FIG. 8B and for the region 412 shown in FIG. 8C (step S24).

Then, the insertion unit 14 inserts dummy metal patterns so that the metal coverage rates of all of the regions including the regions 312, 412 are substantially the same (step S25).

At this time, the insertion unit 14 inserts the dummy metal patterns so that the metal coverage rates of all of the regions are close to 50% or more possibly and are substantially the same.

The insertion unit 14 inserts a dummy metal pattern 313 into the region 312 of FIG. 8B. The insertion unit 14 inserts a dummy metal pattern 413 into the region 412 of FIG. 8C. Such insertion allows the metal patterns including metal patterns 311 and 411 to have the same rate of variation of film thickness so that the clock skew is prevented.

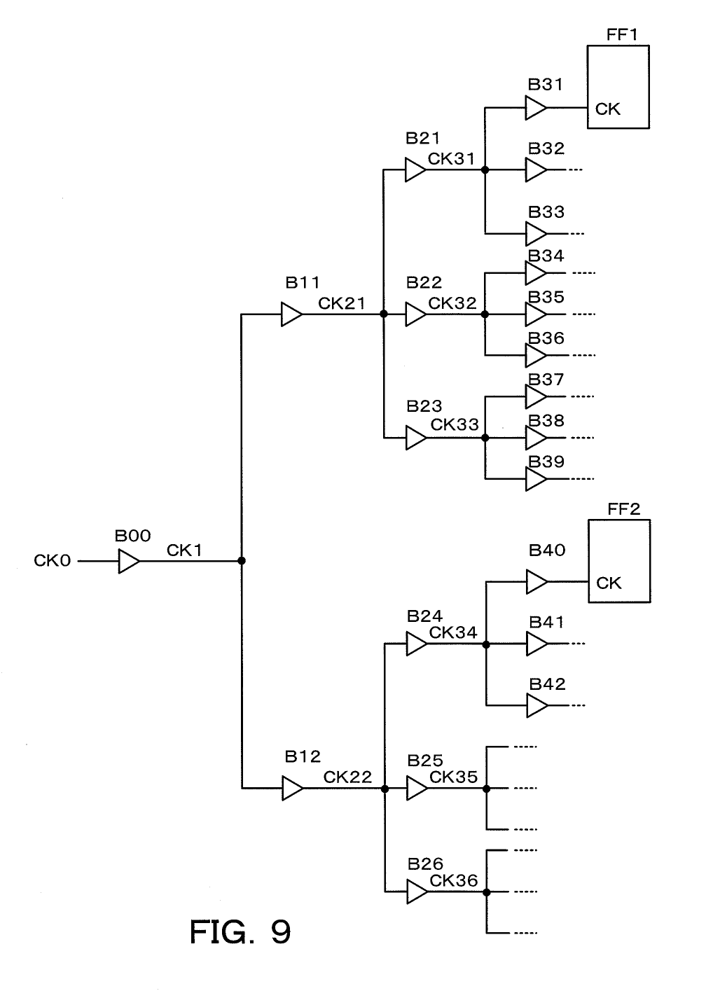

Such a processing of clock wiring is carried out for each branch level of the clock tree. An example of the processing will be described using a clock tree network shown in FIG. 9 to which a clock signal CK0 is provided.

In FIG. 9, the clock tree network is provided with buffers B00, B11, B12, B21 to B26, B31 to B42, . . . , and flip-flops FF1, FF2, . . . . In the clock tree network, a clock signal CK1 is a signal running in wirings divided by a first branch level. Clock signals CK21 and CK22 are signals running in wirings divided by a second branch level respectively. Clock signals CK31, CK32, CK33, CK34, CK35 and CK36 are signals running in wirings divided by a third branch level respectively.

When “CK1” is inputted to the system 1 shown in FIG. 1 as a name of a designated clock signal, a processing of the flow shown in FIG. 7 is performed for a clock wiring of the first branch level. When “CK21” or “CK22” is inputted to the system 1 shown in FIG. 1 as a name of a designated clock signal, a processing of the flow shown in FIG. 7 is performed for a clock wiring of the second branch level.

Similarly, when any one of “CK31”, “CK32”, “CK33”, “CK34”, “CK35” or “CK36” is inputted to the system 1 shown in FIG. 1 as a name of a designated clock signal, a processing of the flow shown in FIG. 7 is performed for a clock wiring of the third branch level.

By performing the above processing, the film thicknesses of the clock wirings of respective branch levels of the clock tree can be substantially the same.

According to the embodiment, though it is difficult to increase the metal coverage rate of an entire chip, the metal coverage rate of a region including a metal wiring of a timing critical path and with a small timing margin can be increased. Accordingly, variation of film thickness of the metal wiring of the timing critical path can be reduced. Furthermore, the regions including metal patterns, through which a clock signal distributed in the clock tree are transmitted, can be designed to have the same metal coverage rate substantially. Accordingly, the rates of variation of film thickness of the metal patterns can be same substantially so that the clock skew is prevented.

A system and a method for designing a semiconductor integrated circuit according to a second embodiment of the invention will be described.

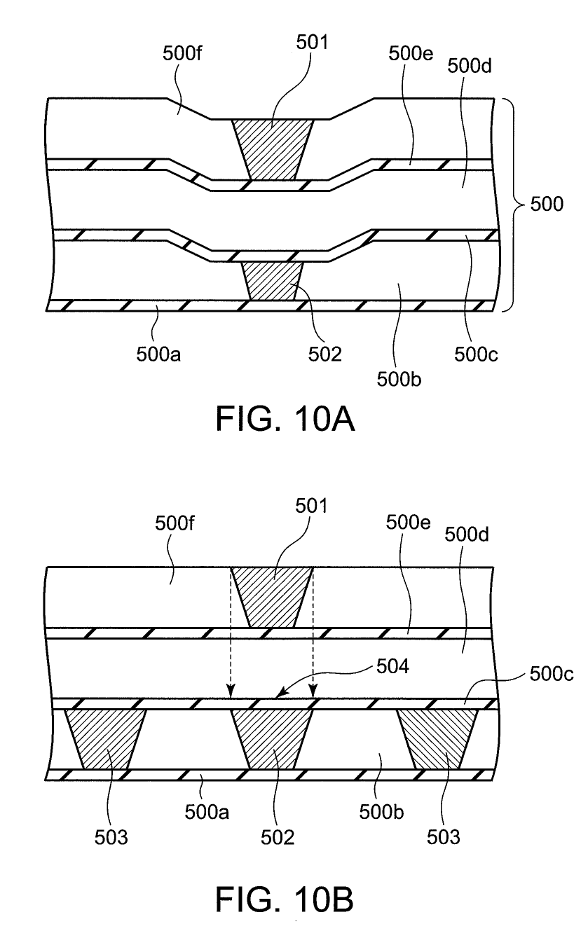

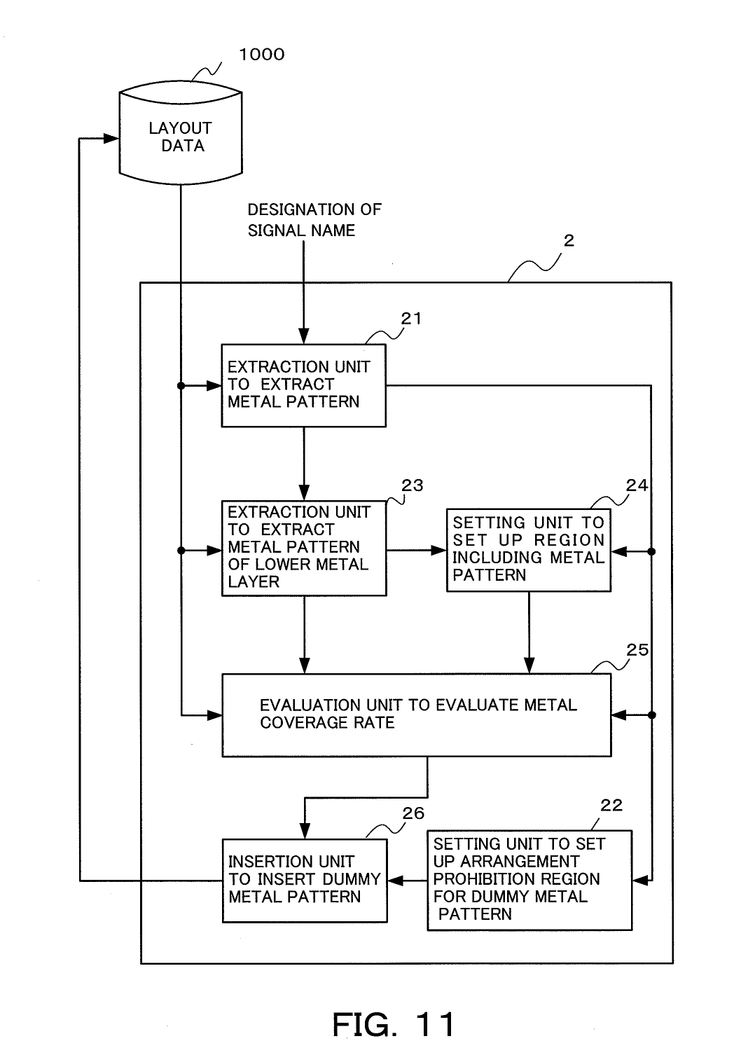

FIGS. 10A, 10B are schematic cross-sectional views for describing a problem of variation in film thickness of metal pattern layers of a multi-layer wired semiconductor integrated circuit and for explaining the improvement. FIG. 11 is a block diagram showing the system according to the second embodiment.

In FIGS. 10A, 10B, insulating layers 500a to 500f constitute an insulating film 500. A metal pattern 502, as a lower metal layer, is formed adjacent to the insulating layer 500b. A metal pattern 501 of a timing critical path, as an upper metal layer, is formed adjacent to the insulating layer 500f. The metal pattern 501 is provided above the metal pattern 502. FIG. 10A shows that the film thickness of the metal pattern 502 is reduced in manufacturing the semiconductor integrated circuit, because the region including the metal pattern 502 as the lower metal layer has a low metal coverage rate.

Such film thickness reduction of the metal pattern 502, which constitutes the lower metal layer, may increase the capacitance of the metal pattern 501 with respect to the substrate. As a result, the timing margin of the timing critical path may be reduced.

To prevent the reduction in timing margin, as shown in FIG. 10b, dummy metal patterns 503, 503 are arranged in the vicinity of the metal pattern 502 constituting the lower metal layer. This can prevent reduction in film thickness of the metal pattern 502 in manufacturing the semiconductor integrated circuit. Therefore, variation of distance of the upper metal pattern 501 from the substrate may be prevented.

Furthermore, in manufacturing the semiconductor integrated circuit, a prohibition region 504, in which arrangement of dummy metal patterns is prohibited, is provided in a lower metal layer which does not contain a metal pattern layer in a vertical direction from the metal pattern 501.

When a dummy metal pattern is arranged as the lower metal layer and the region including the dummy metal pattern has a low metal coverage rate, the dummy metal pattern may vary in film thickness. The variation in film thickness may possibly influence the distance between the substrate and the upper metal pattern 501 of the timing critical path. The reason for providing the prohibition region 504 is to prevent the timing margin of the upper metal pattern 501 from being reduced.

With reference to FIG. 11, a system for designing a semiconductor integrated circuit according to the second embodiment will be described. The system is capable of providing a prohibition region 504.

As shown in FIG. 11, a system 2 for designing a semiconductor integrated circuit includes extraction units 21, 23, setting units 22, 24, an evaluation unit 25 and an insertion unit 26.

The extraction unit 21 extracts a metal pattern 501 corresponding to the designated signal name from the layout data stored in the memory device 1000. The extraction unit 23 extracts a metal pattern 502 of a lower metal layer which is located in a vertical direction from the arrangement position of the extracted metal pattern 501, from the layout data.

The setting unit 22 sets up a prohibition region in each metal layer, which is located below the layer of the metal pattern 501 extracted by the extraction unit 21. The prohibition region is provided to prohibit the arrangement of dummy metal patterns at a position in a vertical direction from the extracted metal pattern 501.

The setting unit 24 sets up a region including the metal pattern 501 extracted by the extraction unit 21. The setting unit 24 sets up another region including the metal pattern 502 extracted by the extraction unit 23.

The evaluation unit 25 calculates the metal coverage rates of the regions set up by the setting unit 24. The evaluation unit 25 evaluates whether each metal coverage rate is equal to or more than a predetermined value.

The insertion unit 26 inserts the dummy metal patterns 503, 503 into a portion, whose metal coverage rate is evaluated as a value smaller than the predetermined value by the evaluation unit 25 and which excludes the region where the arrangement of the dummy metal patterns is prohibited.

A method of inserting dummy metal patterns into a metal pattern layer of a timing critical path, which uses the system 2, will be described. The path is formed in a semiconductor integrated circuit having a multi-layer wired structure.

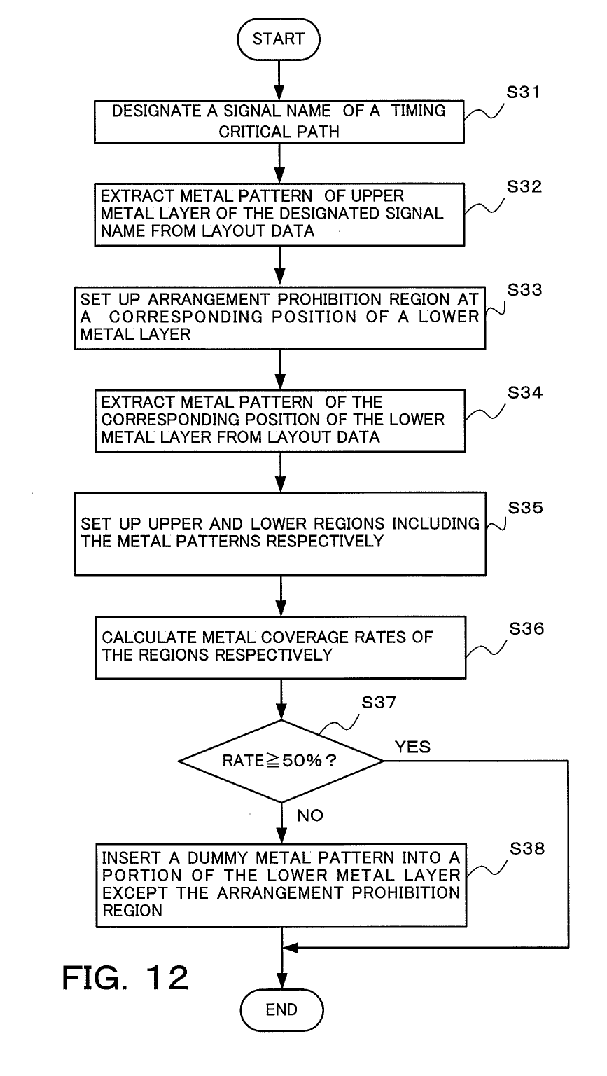

FIG. 12 shows a flowchart to execute the method. In FIG. 12, after start of the processing of the flow, a signal name of the timing critical path is inputted to the system 2 to designate the signal name, in order to start the processing of the flow of FIG. 12 (step S31).

In response to the designation of the signal name, the extraction unit 21 extracts the metal pattern layer 501 of the path from the layout data stored in the memory device 1000 (step S32).

Then, the setting unit 22 sets up an arrangement prohibition region for a dummy metal pattern in a region located in a vertical direction from the extracted metal pattern in each metal layer below the layer including the extracted metal pattern (step S33).

If a metal pattern 502 of a lower metal layer is located in a vertical direction from the arrangement position of the metal pattern 501 of the path, the extraction unit 23 extracts a lower metal pattern 502 from the layout data (step S34).

Subsequently, the setting unit 24 sets up a region including the metal pattern layer 501 extracted by the extraction unit 21. Further, the setting unit 24 sets up a region including the metal pattern 502 extracted by the extraction unit 23 (step S35).

After the set-up, the evaluation unit 25 calculates the metal coverage rate of each region (step S36). Then, the evaluation unit 25 evaluates whether each of the calculated metal coverage rates is equal to or more than 50% (step S37).

As a result of the evaluation at step S37, the processing of the flow is terminated for the regions which have a metal coverage rate of 50% or more.

On the other hand, the insertion unit 26 inserts dummy metal patterns when the metal coverage rate is less than 50%. If the region including the metal pattern 502 contains the arrangement prohibition region which is set up in the previous step 33, the insertion unit 26 inserts the dummy metal patterns 503 into a portion other than the dummy metal pattern arrangement prohibition region (step S38).

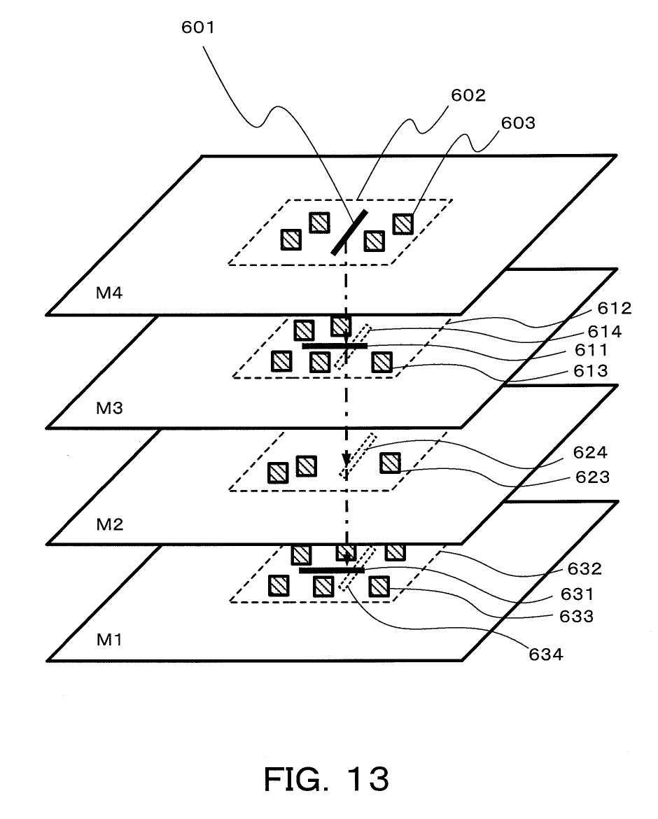

FIG. 13 is a pattern layout view schematically showing an execution example of the flow of FIG. 12. In FIG. 13, metal layers M1 to M4 constitute a semiconductor integrated circuit. FIG. 13 shows an example where a metal pattern 601 of a timing critical path is extracted in the upper metal layer M4, by the extraction unit 21.

In this case, the setting unit 22 sets up arrangement prohibition regions 614, 624, 634 for a dummy metal pattern in portions of the lower metal layers M3, M2, M1 which are located in a vertical direction from the metal pattern 601, respectively.

The extraction unit 23 extracts metal patterns 611, 631 of the metal layers M3, M1 in a vertical direction from the metal pattern 601.

Furthermore, the setting unit 24 sets up regions 602, 612, and 632 including the metal patterns 601, 611, 631, respectively.

Subsequently, the evaluation unit 25 calculates and evaluates the metal coverage rate of each of the regions 602, 612, 632. As a result of the evaluation, if the metal coverage rate of each region is not large enough, dummy metal patterns 603, 613, 633 are inserted into the regions 602, 612, 632, respectively. The dummy metal patterns are not inserted into the arrangement prohibition regions 614, 634.

In the metal layer M2 in which a metal pattern is not included in a vertical direction from the metal pattern 601, a dummy metal pattern 623 is inserted into the portion except the arrangement prohibition region 624, in the case where the dummy metal pattern needs to be inserted for another timing critical path, for example.

According to the embodiment, in the case where there is an upper metal pattern of a timing critical path, and also where a lower metal pattern exists in a vertical direction from the arrangement position of the upper metal pattern, a dummy metal pattern is inserted into a region including the lower metal pattern so that the metal coverage rate may be equal to or more than the predetermined value.

If a lower metal pattern is not located in a vertical direction from the upper metal pattern, a region below the arrangement position of the upper metal pattern is set up as the arrangement prohibition region for a dummy metal pattern. This processing can prevent the distance between a substrate and the metal pattern of a timing critical path and formed in an upper metal layer from being varied by the influence of variation of film thickness of a lower metal pattern.

In the embodiments, the extraction units 11, 21 extract metal patterns corresponding to inputted signal names. However, the extraction units may extract the metal patterns by designating names other than the signal names, or codes, which are previously associated with the metal patterns.

Other embodiments or modifications of the present invention will be apparent to those skilled in the art from consideration of the designation and practice of the invention disclosed herein. It is intended that the designation and example embodiments be considered as exemplary only, with a true scope and spirit of the invention being indicated by the following.

What is claimed is:

1. A system for designing a semiconductor integrated circuit, comprising:
a first extraction module configured to extract a first metal pattern of a semiconductor integrated circuit from layout data;
a first setting module to set a first region comprising the first metal pattern extracted by the extraction module;
an evaluation module configured to calculate the metal coverage rate of the first region and to evaluate whether the metal coverage rate is equal to or greater than a predetermined value; and
an insertion module configured to insert a dummy metal pattern into the first region when the metal coverage rate is evaluated as a value smaller than the predetermined value by the evaluation module.

2. The system of claim 1,
wherein the first setting module is configured to set a second region comprising an area larger than the first region and comprising the first metal pattern;
the evaluation module configured to calculate the metal coverage rate of the first region and to evaluate whether the calculated metal coverage rate are is equal to or greater than the predetermined value when the metal coverage rate of the first region is evaluated as a value smaller than the predetermined value after the dummy metal pattern is inserted into the first region; and
the insertion module is configured to insert a dummy metal pattern into the second region when the metal coverage rate is evaluated as a value smaller than the predetermined value by the evaluation module.

3. The system of claim 1,
wherein the first setting module is configured to set second regions comprising areas larger than the first region comprising the first metal pattern, the evaluation module is configured to calculate the metal coverage rates of the second regions in an order from the second region comprising the smallest area to the second region comprising the largest area when the evaluated metal coverage rate of the first region is smaller than the predetermined value after the dummy metal pattern is inserted into the second region, and the insertion module is configured to insert dummy metal patterns into the second regions when the corresponding evaluated metal coverage rates are smaller than the predetermined value.

4. The system of claim 3,
wherein the metal coverage rate of one of the second regions comprising an area larger than an area of one of the first and the second regions is calculated when an insertion space is not large enough to dispose a dummy metal pattern in the one of the first and the second regions.

5. The system of claim 1, wherein the semiconductor integrated circuit comprises a clock wiring of a clock tree configured to transmit a clock signal, the clock wiring comprising the first metal pattern.

6. The system of claim 5,
wherein the first setting module is configured to set a plurality of third regions other than the first region comprising metal patterns, the evaluation module is configured to calculate the metal coverage rates of the third regions and to evaluate whether the calculated metal coverage rates are equal to or greater than the predetermined value, and the insertion module is configured to insert a dummy metal pattern into the first and the third regions in such a manner that the metal coverage rates of the first and the third regions are substantially the same.

7. The system of claim 1, wherein the semiconductor integrated circuit comprises a multilayer wired structure.

8. The system of claim 7, further comprising a second setting module configured to set an arrangement prohibition region configured to prohibit arrangement of a dummy metal pattern,
wherein the arrangement prohibition region is in a vertical direction from the first metal pattern and in a second metal layer lower than the first metal layer comprising the first metal pattern extracted by the first extraction module.

9. The system of claim 8, further comprising a second extraction module,
wherein the second extraction module is configured to extract a second metal pattern of the second metal layer in the vertical direction from the layout data;
the second setting module is configured to set up a third region comprising the second metal pattern;
the evaluation module is configured to calculate the metal coverage rate of the third region and to evaluate whether the metal coverage rate is equal to or greater than the predetermined value; and
the insertion module is configured to insert a dummy metal pattern into the third region except for the arrangement prohibition region when the metal coverage rate is evaluated as a value smaller than the predetermined value by the evaluation module.

10. A method for designing a semiconductor integrated circuit, comprising:
extracting a first metal pattern of a semiconductor integrated circuit from layout data;
setting a first region comprising the first metal pattern;
calculating the metal coverage rate of the first region and evaluating whether the metal coverage rate is equal to or greater than a predetermined value; and
inserting a dummy metal pattern into the first region when the metal coverage rate is evaluated as a value smaller than the predetermined value.

11. The method of claim 10, further comprising:
setting a second region comprising an area larger than the first region and including the first metal pattern;
calculating the metal coverage rate of the second region and evaluating whether the calculated metal coverage rate are is equal to or greater than the predetermined value when the metal coverage rate of the first region is evaluated as a value smaller than the predetermined value after the dummy metal pattern is inserted into the first region; and
inserting a dummy metal pattern into the second region when the metal coverage rate is evaluated as a value smaller than the predetermined value.

12. The method of claim 10, further comprising:
setting second regions comprising areas larger than the first region comprising the first metal pattern;
calculating the metal coverage rates of the second regions in an order from the second region comprising the smallest area to the second region comprising the largest area when the evaluated metal coverage rate of the first region is smaller than the predetermined value after the dummy metal pattern is inserted into the first region; and
inserting dummy metal patterns into the second regions when the corresponding evaluated metal coverage rates are smaller than the predetermined value.

13. The method of claim 12,
wherein the metal coverage rate of one of the second regions comprising an area larger than an area of one of the first and the second regions is calculated, when an insertion space is not large enough to dispose a dummy metal pattern in the one of the first and the second regions.

14. The method of claim 10, wherein the semiconductor integrated circuit comprises a clock wiring of a clock tree configured to transmit a clock signal, the clock wiring comprising the first metal pattern.

15. The method of claim 14, further comprising:
setting a plurality of third regions other than the first region comprising metal patterns,
calculating the metal coverage rates of the third regions and evaluating whether the calculated metal coverage rates are equal to or greater than the predetermined value; and
inserting a dummy metal pattern into the first and the third regions in such a manner that the metal coverage rates of the first and the third regions are substantially the same.

16. The method of claim 10, wherein the semiconductor integrated circuit comprises a multilayer wired structure.

17. The method of claim 16, further comprising setting an arrangement prohibition region configured to prohibit arrangement of a dummy metal pattern, wherein the arrangement prohibition region is in a vertical direction from the first metal pattern and in a second metal layer lower than the first metal layer comprising the first metal pattern extracted by the first extraction module.

18. The method of claim 17, further comprising:
extracting a second metal pattern of the second metal layer in the vertical direction from the layout data;
setting a third region comprising the second metal pattern;
calculating the metal coverage rate of the third region and evaluating whether the metal coverage rate is equal to or greater than the predetermined value; and
inserting a dummy metal pattern into the third region except for the arrangement prohibition region when the evaluated metal coverage rate is smaller than the predetermined value.
